(19) United States
(12) Patent Application Publication
(10) Pub. No.: US 2003/0193746 A1
(43) Pub. Date: Oct. 16, 2003

(54) Thin film head with non-magnetic insulating layer surrounding upper magnetic pole piece

(75) Inventor: Yoshinori Otsuka, Kawasaki (JP)

Correspondence Address: Patrick G. Burns, Suite 2500, 300 South Wacker Drive, Chicago, IL, 60606, US

(73) Assignee: Fujitsu Limited, Kawasaki-shi (JP)

(21) Appl. No.: 10/454,322

(22) Filed: Jun. 4, 2003

Related U.S. Application Data
(62) Division of application No. 09/761,976, filed on Jan. 17, 2001.
Application No. 09/761,976 is a continuation of application No. PCT/JP99/00332, filed on Jan. 27, 1999.

(30) Foreign Application Priority Data
Sep. 28, 1998 (JP) 10-272712

(51) Int. Cl. G11B 5/147

(52) U.S. Cl. 360/126

(57) ABSTRACT

A non-magnetic gap layer is formed on a lower magnetic core layer. A magnetic layer for an upper magnetic pole piece as well as a non-magnetic cap layer is sequentially formed on the non-magnetic gap layer. A lower magnetic pole piece is shaped out of the lower magnetic core layer by employing the upper magnetic pole piece as a mask. A non-magnetic insulating layer is then formed all over the surface of the lower magnetic core layer. The non-magnetic cap layer is completely covered with the non-magnetic insulating layer. The non-magnetic insulating layer is then subjected to a flattening polishing process until the non-magnetic cap layer is exposed. The exposed non-magnetic cap layer is removed to expose the upper magnetic pole piece. The upper magnetic pole piece suffers from no abrasion in the flattening polishing process, so that the thickness of a narrower auxiliary upper magnetic pole can be set at a predetermined thickness at a higher accuracy.

### BACKGROUND OF THE INVENTION

1. Field of the Invention

The present invention relates to a method of making a thin film magnetic head in general employed in a magnetic disk drive or a magnetic tape drive. In particular, the invention relates to a method of making a thin film magnetic head including a lower magnetic core layer, a gap or non-magnetic layer, and a narrower auxiliary upper magnetic pole designed to interpose the gap layer between the lower magnetic layer and itself.

2. Description of the Prior Art

A coil pattern is in general employed to generate a magnetic flux or field in a thin film magnetic head, namely, an inductive electromagnetic transducer. The generated magnetic flux is allowed to circulate through upper and lower magnetic core layers. The upper and lower magnetic core layers are designed to oppose the tip ends to a recording medium such as a magnetic recording disk. A gap or non-magnetic layer between the tip ends of the upper and lower magnetic core layers serves to induce a leakage of the magnetic flux or field toward the recording medium. The thus leaking magnetic flux or field can be employed to record the binary magnetic data into the recording medium. The width of a recording track defined on the recording medium thus depends on the width of the tip ends of the upper and lower magnetic core layers opposed to the recording medium.

A recent technique proposes a narrower auxiliary upper magnetic pole integrally formed at the tip end of the upper magnetic layer. The narrower auxiliary upper magnetic pole is opposed to the lower magnetic core layer at the tip end of the upper magnetic core layer. Employment of the narrower auxiliary upper magnetic pole enables reduction in the width of a recording track on the recording medium. The density of the recording tracks can thus be improved. In other words, a narrower auxiliary upper magnetic pole contributes to a still higher recording density of the recording medium.

As disclosed in Japanese Patent Application Laid-open No. 09-270105, for example, an upper magnetic pole piece as the auxiliary upper magnetic pole is formed independent of formation of the upper magnetic core layer prior to formation of a thin film coil pattern. If the upper magnetic pole piece can be formed on a flat surface of the gap layer prior to formation of the thin film coil pattern, a relatively thin photoresist can be employed to pattern the contour of the upper magnetic pole piece. Such a thin photoresist contributes to formation of a narrower upper magnetic pole piece. The upper magnetic core layer is then formed to overlie on the upper magnetic pole piece. The upper magnetic pole piece thus serves to establish a narrower auxiliary upper magnetic pole continuous to the tip end of the upper magnetic core layer.

It is preferable to restrict the thickness of the auxiliary upper magnetic pole in a predetermined range in the aforementioned thin film magnetic head. The thickness can be measured in the longitudinal direction of a recording track. If the auxiliary upper magnetic pole is too thin, the upper magnetic core layer extending outward from the lateral ends of the auxiliary upper magnetic pole is expected to make a magnetic blur at the boundary of the recording track. An increased density of recording tracks thus cannot be established as expected. On the other hand, if the auxiliary upper magnetic pole is too thick, the intensity of the magnetic field for recordation is reduced, so that the recordation itself possibly fails.

The method disclosed in the aforementioned Japanese Patent Application should include the process of covering the upper magnetic pole piece with a non-magnetic insulating layer prior to formation of a thin film coil pattern. Moreover, the non-magnetic insulating layer covering over the upper magnetic pole piece should be subjected to a flattening polishing process. The flattening polishing process serves to expose the upper surface of the upper magnetic pole piece flush with the polished surface of the non-magnetic insulating layer. The upper magnetic core layer is then formed to cover over the polished surface including the exposed surface of the upper magnetic pole piece. In this method, the thickness of the auxiliary upper magnetic pole suffers from variation depending on the amount of polishing effected on the upper magnetic pole piece. It is very difficult to accurately control the thickness of the upper magnetic pole piece in the flattening polishing process.

### SUMMARY OF THE INVENTION

It is accordingly an object of the present invention to provide a method of making a thin film magnetic head, capable of establishing the auxiliary upper magnetic pole of a predetermined thickness in a facilitated manner.

According to the present invention, there is provided a method of making a thin film magnetic head, comprising: forming a lower magnetic core layer; forming a non-magnetic gap layer; forming an upper magnetic pole piece on the non-magnetic gap layer; forming a non-magnetic cap layer on the upper magnetic pole piece; forming a non-magnetic insulating layer covering over the non-magnetic cap layer and the upper magnetic pole piece; flattening the non-magnetic insulating layer so as to expose the non-magnetic cap layer; removing the non-magnetic cap layer so as to expose the upper magnetic pole piece; and forming an upper magnetic core layer continuous to the upper magnetic pole piece.

In the case where a chemical mechanical polishing (CMP) process is for example employed as the flattening polishing process, the observation of the reactive or abrasive load serves to reveal the moment when the non-magnetic layer has just gotten exposed. The polishing process can be terminated right at this moment. This is a well-known technique. A reliable termination of the polishing process right at the moment when the non-magnetic layer has been exposed contributes to a precise control of the amount of abrasion during the flattening polishing process. When the upper magnetic core layer is subsequently formed in place of the removed non-magnetic layer, a part of the upper magnetic core layer forms a narrower auxiliary upper magnetic pole in cooperation with the upper magnetic pole piece. Accordingly, if the thickness of the non-magnetic layer and the upper magnetic pole piece can properly be determined, the narrower auxiliary upper magnetic pole of a predetermined thickness can be obtained in a facilitated manner.

The aforementioned method is expected to contribute to establishment of a thin film head comprising: a lower magnetic layer; a non-magnetic gap layer overlying on the lower magnetic layer; an upper magnetic pole piece formed on the non-magnetic gap layer; a non-magnetic insulating layer surrounding the upper magnetic pole piece so as to define a depression on an upper surface of the upper magnetic pole piece; and an upper magnetic layer connected to the upper magnetic pole piece.

If the depression has a larger depth, the upper magnetic core layer may completely be contained within the depression on the upper magnetic pole piece. The upper magnetic core layer can be prevented to the utmost from extending outward from the lateral ends of the upper magnetic pole piece in the direction of the width of the recording track. The outward extension of the upper magnetic core layer from the lateral ends of the upper magnetic pole piece tends to induce a magnetic blur at the boundary of the recording tracks on the recording medium.

A lower magnetic pole piece may be formed on the upper surface of the lower magnetic layer under the non-magnetic gap layer, for example. The lower magnetic pole piece serves to form a narrow gap in cooperation with the aforementioned narrower upper magnetic pole piece. A narrower magnetic field can be formed to cross the narrower gap. If such a narrower magnetic field can be employed to write magnetic binary data into a recording medium, a narrower recording track can be defined on the recording medium.

The method may further include the following steps so as to form the aforementioned lower magnetic pole piece: sequentially forming the non-magnetic gap layer, the upper magnetic pole piece and the non-magnetic cap layer on the upper surface of the lower magnetic layer; and patterning a contour of the lower magnetic pole piece with the upper magnetic pole piece and the non-magnetic cap layer in forming the lower magnetic pole piece. The steps contributes to a reliable formation of the lower magnetic pole piece aligned relative to the upper magnetic pole piece at a higher accuracy in a facilitated manner. Specifically, the lower magnetic pole piece, the non-magnetic gap layer and the upper magnetic pole piece are patterned in the identical contour in the resulting thin film head.

It is preferable that the non-magnetic cap layer is made from a material having an etching ratio different from that of the non-magnetic insulating layer and/or the non-magnetic gap layer. Such a difference enables removal of the non-magnetic gap layer while keeping the non-magnetic cap layer remaining or removal of the non-magnetic cap layer while keeping the non-magnetic insulating layer remaining in a reactive ion etching process. In these cases, the non-magnetic cap layer may be made from SiO₂, while the non-magnetic insulating layer and/or the non-magnetic gap layer is made from Al₂O₃, for example. Alternatively, the non-magnetic cap layer may be made from Al₂O₃, while the non-magnetic insulating layer and/or the non-magnetic gap layer is made from SiO₂. Otherwise, the non-magnetic cap layer may be a non-magnetic metallic layer, while the non-magnetic insulating layer and/or the non-magnetic gap layer are oxide insulating layers, for example.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a plan view illustrating the interior structure of a hard disk drive (HDD);

FIG. 2 is an enlarged perspective view illustrating a specific example of a flying head slider;

FIG. 3 is an enlarged sectional view schematically illustrating the structure of an electromagnetic transducer;

FIG. 4 is a plan view schematically illustrating the structure of a thin film magnetic head element;

FIGS. 5A and 5B are detailed perspective views illustrating the structure of the tip end of the thin film magnetic head element;

FIGS. 6A-6C schematically illustrate the method of making the flying head slider;

FIGS. 7A-7E schematically illustrate the method of making the thin film magnetic head element; and

FIGS. 8A-8D schematically illustrate a flattening polishing process effected on the thin film magnetic head element.

### DESCRIPTION OF THE PREFERRED EMBODIMENT

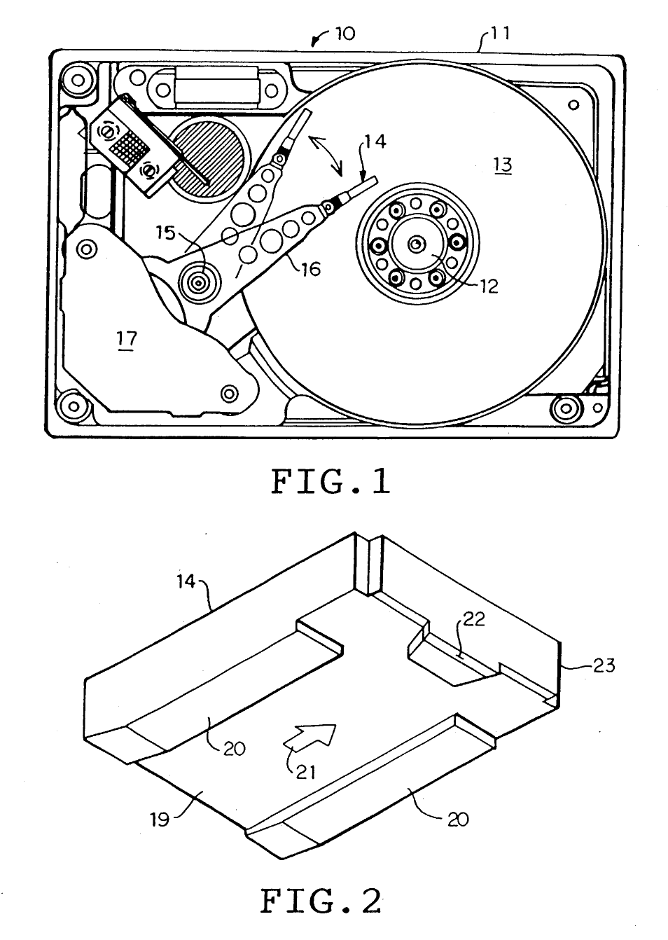

FIG. 1 illustrates the interior structure of a hard disk drive (HDD) 10 as an example of a magnetic storage apparatus. The HDD 10 includes an primary enclosure 11 incorporating one or more magnetic recording disks 13 mounted on a rotational shaft 12 and flying head sliders 14 opposed to the corresponding surfaces of the respective magnetic recording disks 13. The individual head slider 14 is fixed on the tip end of a carriage arm 16 capable of swinging about a support shaft 15. When magnetic binary data is written into or read out of the magnetic recording disk 13, an electromagnetic actuator 17 serves to drive the carriage arm 16 for swinging movement, so that the flying head slider 14 can be positioned right above a target recording track defined on the surface of the magnetic recording disk 13. A cover, not shown, is coupled to the primary enclosure 11 so as to define an airtight inner space between the primary enclosure 11 and itself.

FIG. 2 illustrates the structure of the flying head slider 14 according to a specific example. The flying head slider 14 includes a slider body designed to define a medium-opposed or bottom surface 19 opposed to the surface of the magnetic recording disk 13. A pair of rails 20 is formed on the slider body so as to extend along the bottom surface 19. Air bearing surfaces are respectively defined on the top surfaces of the rails 20. The flying head slider 14 is designed to receive airflow 21 at the bottom surface 19, in particular, at the air bearing surfaces, during rotation of the magnetic recording disk 13. The flying head slider 14 is thus allowed to fly above the surface of the rotating magnetic recording disk 13. A head-containing layer 23 is coupled to the trailing or downstream end of the slider body. An electromagnetic transducer or read/write head element 22 is embedded within the head-containing layer 23, as described later in detail. In general, the slider body is made from Al₂O₃—TiC, and the head-containing layer is made from Al₂O₃.

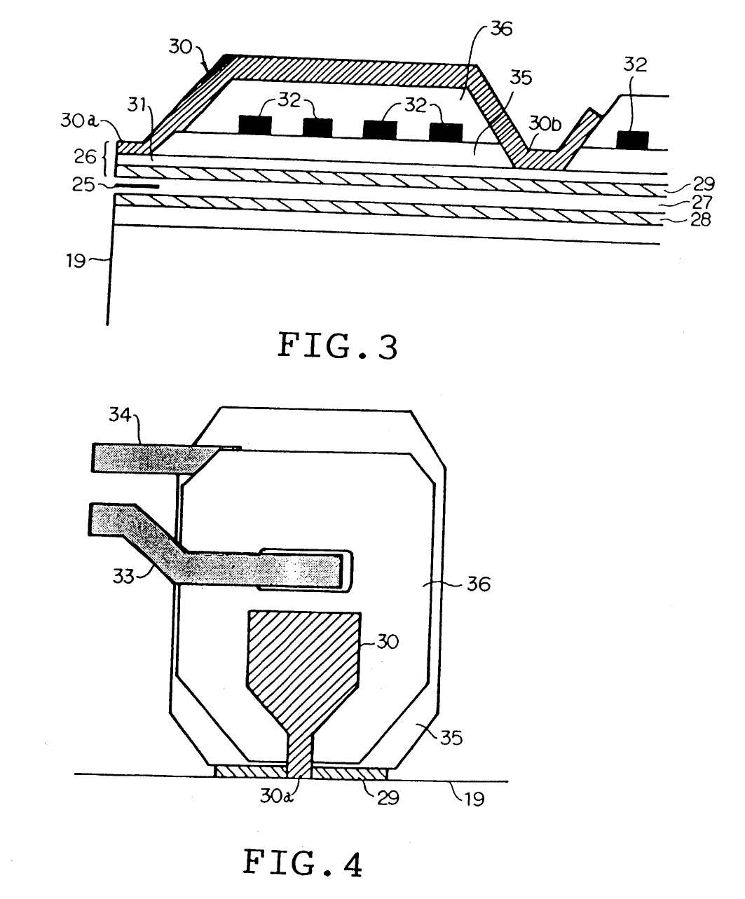

Referring to FIG. 3, a brief description will be made on the structure of the electromagnetic transducer 22 according to the present invention. The electromagnetic transducer 22 embedded in the head-containing layer 23 includes a read head element such as a magnetoresistive (MR) element 25 exposing its tip end at the bottom surface 19, and a write head element such as a thin film magnetic head element 26 likewise exposing its tip end at the bottom surface 19. The MR element 25 embedded within an Al₂O₃ layer 27 is interposed between lower and upper shield layers 28, 29 made from FeN, NiFe, or the like.

The thin film magnetic head element 26 includes an upper magnetic core pattern 30 cooperating with the upper shield layer 29 of the MR element 25 to form a magnetic core. In this case, the upper shield layer 29 for the MR element 25 functions as a lower magnetic core layer or pattern of the thin film magnetic head element 26. The tip end of the upper magnetic core pattern 30, namely, the upper magnetic pole 30a is designed to interpose a non-magnetic gap layer 31 between the upper shield layer 29 and itself. The non-magnetic gap layer 31 serves to establish a write gap for recordation between the upper magnetic pole 30a and the upper shield layer 29. The non-magnetic gap layer 31 also serves to establish a back gap for magnetically connecting the rear end 30b of the upper magnetic core pattern 30 and the upper shield layer 29. When electric current is supplied to a thin film swirly coil pattern 32, a magnetic flux can be generated in the rear end 30b of the upper magnetic core pattern 30 at the center of the swirly coil pattern 32. The generated magnetic flux is allowed to circulate through the upper magnetic core pattern 30 and the upper shield layer 29. The circulation of the magnetic flux induces a magnetic field for recordation at the write gap.

Referring also to FIG. 4, a first lead pattern 33 is connected to the central or innermost end of the swirly coil pattern 32. A second lead pattern 34 is also connected to the outermost end of the swirly coil pattern 32. The coil pattern 32 is designed to receive electric current through the first and second lead patterns 33, 34. The coil pattern 32 is interposed between a lower insulating layer 35 overlying on the non-magnetic gap layer 31 and an upper insulating layer 36 overlying on the lower insulating layer 35.

As is apparent from FIG. 4, the upper magnetic pole 30a adjacent the write gap at the bottom surface 19 of the slider body defines the width of a recording track defined on the surface of the magnetic recording disk 13. The magnetic flux circulating through the upper magnetic core pattern 30 and the upper shield layer 29 is exchanged between the upper magnetic pole 30a and the upper shield layer 29 both opposed to the surface of the magnetic recording disk 13 across the write gap along the bottom surface 19.

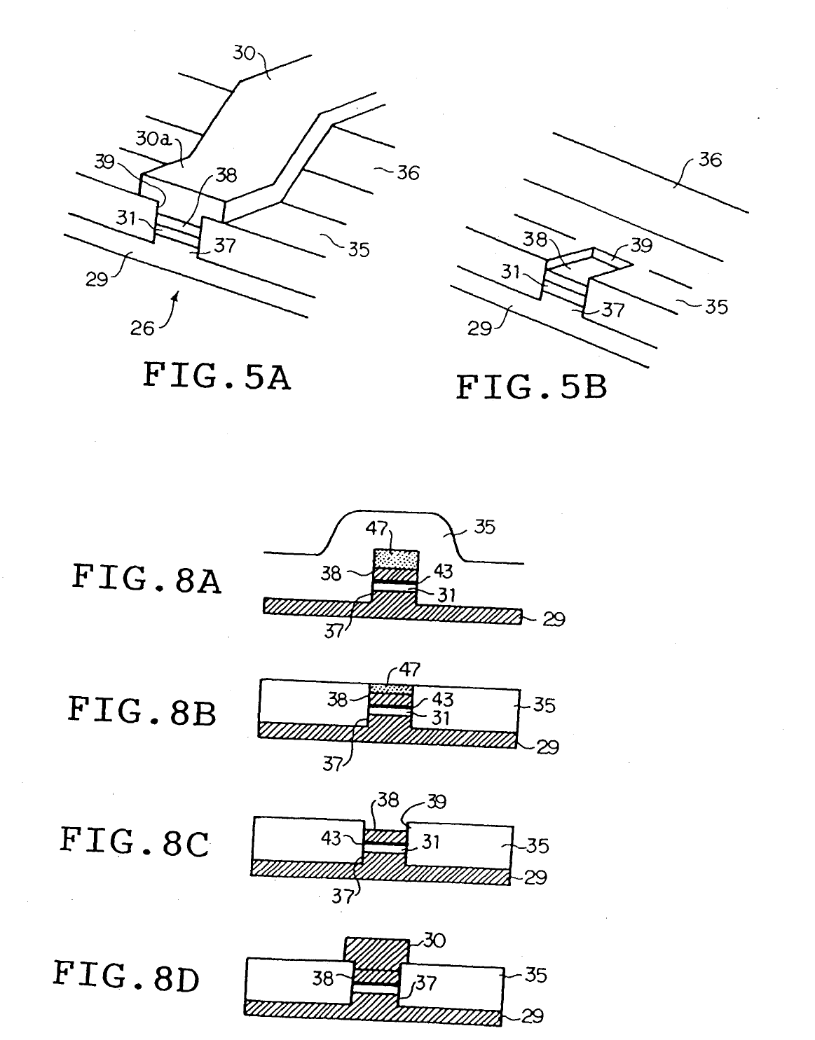

Now, a detailed description will be made on the thin film magnetic head element 26 in the vicinity of the write gap, referring to FIG. 5A. The thin film magnetic head element 26 further includes a lower magnetic pole piece 37 swelling from the upper surface of the upper shield layer or lower magnetic core layer 28. The lower magnetic pole piece 37 may be engraved out of the upper shield layer or lower magnetic core layer 28. Otherwise, the lower magnetic pole piece 37 may be formed by a small magnetic layer anew formed over the upper shield layer 29.

An upper magnetic pole piece 38 is superposed on the lower magnetic pole piece 37. The non-magnetic gap layer 31 is interposed between the upper and lower magnetic pole pieces 38, 37. As is apparent from FIG. 5B, the lower magnetic pole piece 37, the gap layer 31 and the upper magnetic pole piece 38 are patterned in the identical shape or contour. The stack of the lower magnetic pole piece 37, the gap layer 31 and the upper magnetic pole piece 38 is surrounded by a non-magnetic insulating layer, namely, the lower insulating layer 35, as described later in detail. The lower insulating layer 35 is designed to define a depression 39. The bottom of the depression 39 is defined by the upper surface of the upper magnetic pole piece 38. The upper magnetic core pattern 30 covering over the upper insulating layer 36 reaches the depression 39 so as to contact the upper magnetic pole piece 38. The depression 39 is thus completely filled with the upper magnetic core pattern 30 or the upper magnetic pole 30a. The upper magnetic pole 30a and the upper magnetic pole piece 38 within the depression 39 establish in cooperation an upper auxiliary magnetic pole of the thin film magnetic head element 26.

The narrower lower magnetic pole piece 37 swelling from the upper surface of the upper shield layer 29 serves to cooperate with the narrower auxiliary upper magnetic pole so as to establish a narrower magnetic field or flux across the write gap. Magnetic binary data can reliably be written into the magnetic recording disk 13 without inducing a magnetic blur at the boundary of recording tracks.

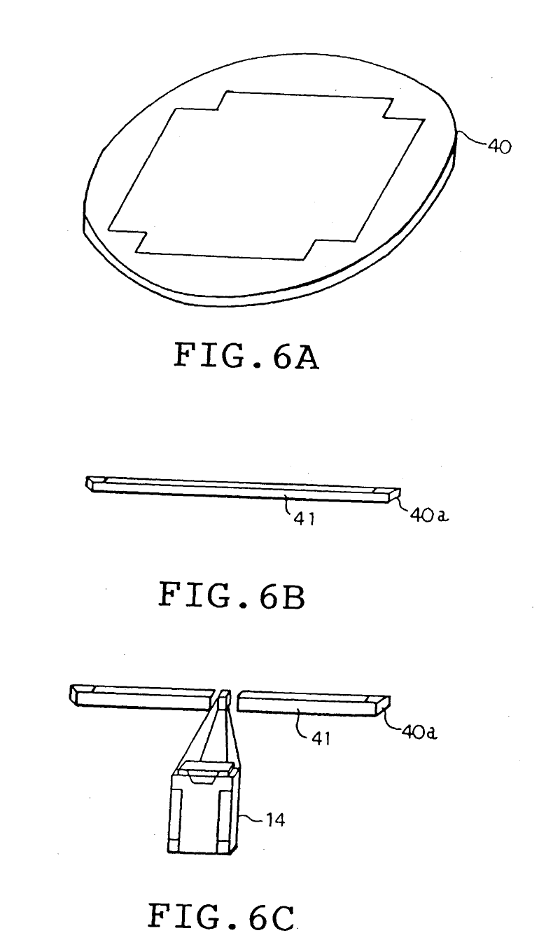

Next, a detailed description will be made on a method of making the flying head slider 14 comprising the aforementioned electromagnetic transducer 22. As shown in FIG. 6A, a large number of the electromagnetic transducers 22 are formed on the surface of a wafer 40 of Al₂O₃—TiC covered with an Al₂O₃ lamination. A block is defined on the surface of the wafer 40 so as to receive the individual electromagnetic transducer 22. The block corresponds to the flying head slider 14. For example, a single wafer 40 of 5 inches diameter corresponds to a bulk of 100×100=10,000 flying head sliders 14. The formed electromagnetic transducers 22 are covered with a non-magnetic insulating layer of Al₂O₃.

As shown in FIG. 6B, a wafer bar 40a is then cut out of the wafer 40. The wafer bar 40a contains a row of the blocks each corresponding to the flying head slider 14. The exposed surface of the wafer bar 40a is shaped or engraved into the aforementioned bottom surface 19 including the rails 20. As shown in FIG. 6C, the individual flying head slider 14 is finally cut out of the wafer bar 40a.

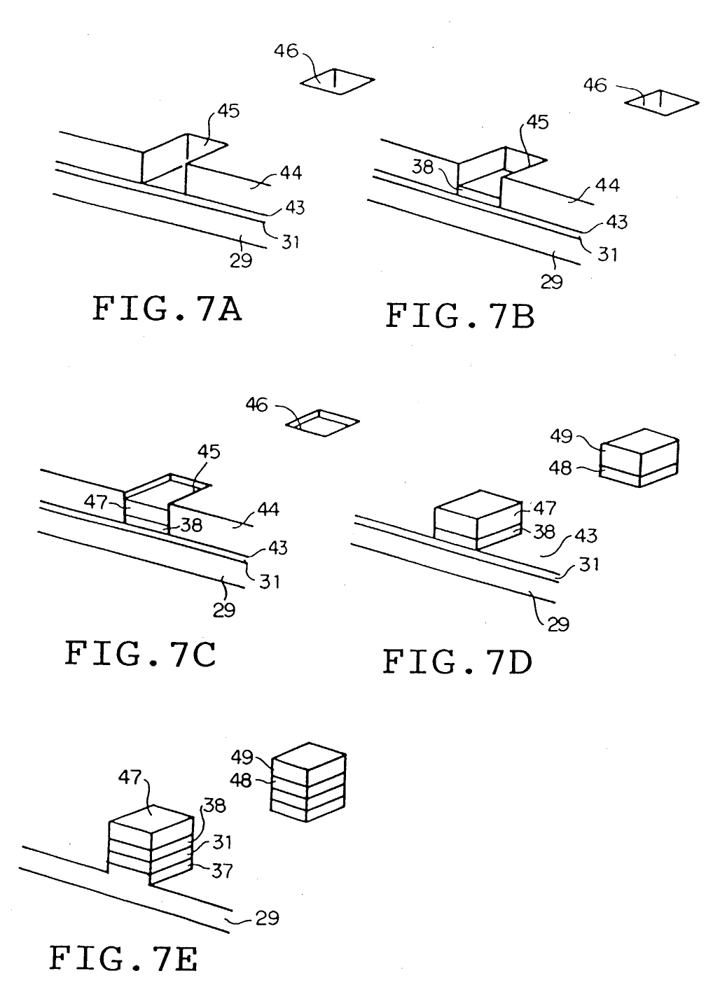

Here, a detailed description will be made on the method of making the electromagnetic transducer 22. First of all, the lower shield layer 28, the MR element 25, the upper shield layer 29 and the non-magnetic gap layer 31 are sequentially formed on the surface of the wafer 40 in a conventional manner, as shown in FIGS. 3 and 4, for example. The non-magnetic gap layer 31 may be made from an oxide such as Al₂O₃ and SiO₂, Al nitride, Si nitride, Ti, Ta, or the like, for example. A conductive base layer 43 is then formed over the surface of the non-magnetic gap layer 31 by sputtering or vapor deposition. The base layer 43 may be made from Ta, NiFe, or the like. A photoresist 44 is thereafter applied to the surface of the base layer 43. As shown in FIG. 7A, the photoresist 44 is then subjected to exposure and development. In exposure and development, the photoresist 44 is masked with a photomask for patterning the contours of the upper magnetic pole piece 38 and the back gap. After the exposure and development, voids 45, 46 are formed in the remaining photoresist 44 so as to expose the upper surface of the base layer 43. The voids 45, 46 are designed to define the contours of the upper magnetic pole piece 38 and the back gap, respectively.

Thereafter, the wafer 40 is subjected to an electroplating. The wafer 40 is dipped in an electrolyte. Electric current is then supplied to the conductive base layer 43. The magnetic material is deposited over the exposed surface of the base layer 43 in the photoresist 44, as shown in FIG. 7B, for example. In this manner, the upper magnetic pole piece 38 is formed within the void 45. The thickness of the deposited magnetic layer is set larger than 0.5 μm, for example, so as to suppress or totally prevent a magnetic blur in a resulting thin film magnetic head element 26.

After the magnetic layer has been formed in the above-described manner, the photoresist 44 is utilized to form a non-magnetic layer over the thus obtained magnetic layer, as shown in FIG. 7C. The non-magnetic cap layer 47 is this time formed within the void 45.

The photoresist 44 is then removed. Ultrasonic cleaning may be employed. As shown in FIG. 7D, a magnetic layer 48 and a non-magnetic cap layer 49 of the identical pattern appear on the base layer 43 in the area corresponding to the void 46 after the removal of the photoresist 44. A non-magnetic cap layer 47 superposed on the upper magnetic pole piece 38 also appear in the area corresponding to the void 45.

The base layer 43 and the unnecessary non-magnetic gap layer 31 are completely removed by ion milling process in a region around the magnetic layers 38, 48 and the non-magnetic cap layers 47, 49. In this ion milling process, the lower magnetic pole piece 37 is simultaneously engraved out of the flat surface of the upper shield layer 29. As shown in FIG. 7E, the stack of the lower magnetic pole piece 37, the gap layer 31, the upper magnetic pole piece 38 and the non-magnetic cap layer 47, standing on the surface of the upper shield layer 29, is thus obtained in the area corresponding to the void 45. In this manner, if the lower magnetic pole piece 37 can be formed by employment of the upper magnetic pole piece 38 as a mask, it is possible to reliably prevent the lower magnetic pole piece 37 from any displacement or misalignment relative to the upper magnetic pole pieces 38.

A non-magnetic insulating layer, namely, the lower insulating layer 35 is uniformly formed to cover all over the surface of the wafer 40. The lower insulating layer 35 may be made from Al₂O₃, for example. As shown in FIG. 8A, the lower insulating layer 35 completely covers over the upper magnetic pole piece 38 and the non-magnetic cap layer 47.

Subsequently, the formed lower insulating layer 35 is subjected to a flattening polishing process until the non-magnetic cap layer 47 is forced to get exposed, as shown in FIG. 8B. In this case, the upper magnetic pole piece 38 is completely prevented from abrasion. The upper magnetic pole piece 38 is thus allowed to keep its thickness which has been established during the electroplating. The flattening polishing process preferably includes a lapping and a chemical mechanical polishing (CMP). In particular, the CMP serves to reliably terminate the polishing process at the moment when the non-magnetic cap layer 47 has gotten exposed. It is thus possible to accurately control the amount of abrasion during the polishing process. In this case, the non-magnetic cap layer 47 is preferably made from SiO₂, Al₂O₃, or the like. In the case where any grain or scratch remains on the polished surface after the polishing process, a flattening process such as an etching back process may be additionally effected on the polished surface.

After the flattening polishing process has been effected, a reactive ion etching process is effected to remove the non-magnetic cap layer 47, as shown in FIG. 8C, for example. The upper magnetic pole piece 38 is thus forced to get exposed. The reactive ion etching process serves to completely remove the non-magnetic cap layer 47 while keeping the upper magnetic pole piece 38 completely remaining. If the non-magnetic cap layer 47 has the etching ratio different from that of the lower insulating layer 35, the thickness of the lower insulating layer 35 cannot be reduced during the removal of the non-magnetic cap layer 47. For example, SiO₂ can be selected for the non-magnetic cap layer 47 if the lower insulating layer 35 is made from Al₂O₃. To the contrary, Al₂O₃ can be selected for the non-magnetic cap layer 47 if the lower insulating layer 35 is made from SiO₂. When the non-magnetic cap layer 47 has been removed in the aforementioned manner, the depression 39 can be defined in the lower insulating layer 35. The upper magnetic pole piece 38 functions as the bottom of the depression 39.

As shown in FIG. 8D, the upper magnetic core pattern 30 is then formed. The upper magnetic pole 30a of the upper magnetic core pattern 30 is connected to the upper magnetic pole piece 38. Formation of the thin film coil pattern 32 and the upper insulating layer 36 may be effected subsequent to the flattening polishing process of the lower insulating layer 35 or the removal of the non-magnetic cap layer 47, but prior to formation of the upper magnetic core pattern 30. In any case, the coil pattern 32 can be formed on the flattened surface of the lower insulating layer 35, so that it is possible to reduce the pitch of the coil pattern 32. The overall magnetic core may be shortened in the thin film magnetic head element 26. The thin film magnetic head element 26 is allowed to achieve a higher performance of overwriting and a superior higher frequency characteristic.

In the aforementioned embodiment, ion milling process is employed to remove the conductive base layer 43, the non-magnetic gap layer 31 and the upper shield layer 29 altogether. A reactive dry etching process may alternatively be employed to remove the gap layer 31 after the base layer 43 has been removed. In the case where the gap layer 31 is made from SiO₂ and the non-magnetic cap layer 47 from Al₂O₃, a chlorine-containing gas such as BCl₃ and Cl₂ may be selected as the process gas. To the contrary, in the case where the gap layer 31 is made from Al₂O₃ and the non-magnetic cap layer 47 from SiO₂, a fluorine-containing gas such as CF₄ and CHF₃ may be selected as the process gas. If the gap layer 31 and the non-magnetic cap layer 47 have the different etching ratios, the removal of the non-magnetic gap layer 31 will not induce reduction in the thickness of the non-magnetic cap layer 47.

It should be noted that the thin film magnetic head element 26 may be employed in combination with any read head element other than the aforementioned MR element 25.

What is claimed is:

1. A method of making a thin film magnetic head, comprising:
forming a lower magnetic core layer;
forming a non-magnetic gap layer;
forming an upper magnetic pole piece on the non-magnetic gap layer;
forming a non-magnetic cap layer on the upper magnetic pole piece;
forming a non-magnetic insulating layer covering over the non-magnetic cap layer and the upper magnetic pole piece;
flattening the non-magnetic insulating layer so as to expose the non-magnetic cap layer;
removing the non-magnetic cap layer so as to expose the upper magnetic pole piece; and
forming an upper magnetic core layer covering over the upper magnetic pole piece.

2. The method of making according to claim 1, further comprising: forming a lower magnetic pole piece on an upper surface of the lower magnetic core layer under the non-magnetic gap layer.

3. The method of making according to claim 2, further comprising:
sequentially forming the non-magnetic gap layer, the upper magnetic pole piece and the non-magnetic cap layer on the upper surface of the lower magnetic core layer; and
patterning a contour of the lower magnetic pole piece with the upper magnetic pole piece and the non-magnetic cap layer in forming the lower magnetic pole piece.

4. The method of making according to claim 3, wherein said non-magnetic cap layer is made from a material having an etching ratio different from that of the non-magnetic insulating layer.

5. The method of making according to claim 4, wherein said non-magnetic cap layer is made from SiO₂, while said non-magnetic insulating layer is made from Al₂O₃.

6. The method of making according to claim 4, wherein said non-magnetic cap layer is made from Al₂O₃, while said non-magnetic insulating layer is made from SiO₂.

7. The method of making according to claim 4, wherein said non-magnetic cap layer is a non-magnetic metallic layer, while said non-magnetic insulating layer is an oxide insulating layer.

8. The method of making according to claim 3, wherein said non-magnetic cap layer is made from a material having an etching ratio different from that of the non-magnetic gap layer.

9. The method of making according to claim 8, wherein said non-magnetic cap layer is made from SiO₂, while said non-magnetic gap layer is made from Al₂O₃.

10. The method of making according to claim 8, wherein said non-magnetic cap layer is made from Al₂O₃, while said non-magnetic gap layer is made from SiO₂.

11. The method of making according to claim 8, wherein said non-magnetic cap layer is a non-magnetic metallic layer, while said non-magnetic gap layer is an oxide insulating layer.

12. A thin film head comprising:
a lower magnetic core layer;
a non-magnetic gap layer overlying over the lower magnetic core layer;
an upper magnetic pole piece formed on the non-magnetic gap layer;
a non-magnetic insulating layer surrounding the upper magnetic pole piece so as to define a depression on an upper surface of the upper magnetic pole piece; and
an upper magnetic core layer connected to the upper magnetic pole piece.

13. The thin film head according to claim 12, further comprising a lower magnetic pole piece swelling from an upper surface of the lower magnetic core layer.

14. The thin film head according to claim 13, wherein said lower magnetic pole piece, the non-magnetic gap layer and the upper magnetic pole piece are patterned in an identical contour.
